(19) United States
(12) Patent Application Publication
(10) Pub. No.: US 2011/0317882 A1
(43) Pub. Date: Dec. 29, 2011

(54) BIOMETRIC MATCHING METHOD AND APPARATUS

(75) Inventor: Sarfaraz Muazam, West Midlands (GB)

(73) Assignee: PIPA SOLUTIONS LTD., London (GB)

(21) Appl. No.: 12/445,994

(22) PCT Filed: Oct. 18, 2007
(86) PCT No.: PCT/GB2007/003987

§ 371 Date: Jun. 13, 2011

(30) Foreign Application Priority Data
Oct. 18, 2006 (GB) 0620694.0

(51) Int. Cl. G06K 9/00

(52) U.S. Cl. 382/117; 382/115; 382/124

(57) ABSTRACT

A biometric matching apparatus comprising, an output, an input for acquiring items of biometric data, a memory and a processor, the memory comprises, a template database in which is stored a plurality of templates of items of biometric data, each template comprising a template identifier, and a sequence database in which is stored a plurality of sequences, each sequence comprising data that corresponds to template identifiers in a stored sequence order, and comprising further data or a sequence identifier for relating to further data, wherein the apparatus comprises a matching mechanism which is configured to match, after a user has entered a series of items of biometric data into the input, each inputted item against templates in the template database by comparing each item with templates and by selecting a number of templates which satisfy predetermined matching criteria based on the inputted item, and creating a list of selected templates for each inputted item, the matching mechanism is configured to store the lists in the memory in a lists order corresponding to the input order of items in the series, and is configured to identify a sequence from the sequence database in which each of the corresponding template identifiers in the sequence order relates to a selected template included in the list of selected templates which is in a position in the stored lists order corresponding to the position of the identifier in the sequence order, and the processor is configured to use the identified sequence to send the corresponding further data or sequence identifier to the output for identification of a user.

The present invention relates to a biometric matching apparatus and a method of matching biometrics and in particular a sequence of biometrics.

It is known to use biometric readers and matching systems for many different functions, in particular where the function requires a level of security. Such known systems may take an image of a retina or a fingerprint of an individual and use matching algorithms to determine the identity of the individual by comparing that image to stored images, which images have been stored with corresponding individual identity details. These may be used for example instead of a password, or in addition to it, to enable access to a computer system.

These systems often either require a complex biometric reader and algorithms. If a more simple reader or algorithms are used this can result in false positive or false negative results. False positive results are particularly problematic since they may, for example, allow an individual without security clearance to access a highly sensitive computer system.

It has also been suggested that entry to certain systems could require multiple finger prints to be scanned such as by requiring an individual to scan the prints of multiple fingers. It has also been suggested that this could be done in a set sequence., to add an extra degree of security.

However the matching algorithms used are designed for use with single biometrics and are inefficiently slow when used with multiple entries. In addition they may either result in many false negatives or positives with individuals wrongly being rejected or accepted. They may also require a long time to scan each biometric in order to receive enough information to prevent false positives or negatives. Problems are caused by the fact that the matching process will look for unique matches for each fingerprint as it would with an isolated biometric. Accordingly they take time to resolve any situations where there are multiple matches. Protocols to insure there is not a false match may also reject correct but badly scanned fingerprints.

It is an object of the present invention to improve on the above systems, in particular to provide a system for use with a series of ordered biometrics which matches them to an individual accurately and rapidly and without requiring excessive computational processing power.

According to a first aspect of the present invention there is provided a biometric matching apparatus comprising, an output, an input for acquiring items of biometric data, a memory and a processor, the memory comprises, a template database in which is stored a plurality of templates of items of biometric data, each template comprising a template identifier, and a sequence database in which is stored a plurality of sequences, each sequence comprising data that corresponds to template identifiers in a stored sequence order, and comprising further data or a sequence identifier for relating to further data, wherein the apparatus comprises a matching mechanism which is configured to match, after a user has entered a series of items of biometric data into the input, each inputted item against templates in the template database by comparing each item with templates and by selecting a number of templates which satisfy predetermined matching criteria based on the inputted item, creating a list of selected templates for each inputted item, the matching mechanism is configured to store the lists in the memory in a lists order corresponding to the input order of items in the series, and is configured to identify a sequence from the sequence database in which each of the corresponding template identifiers in the sequence order relates to a selected template included in the list of selected templates which is in a position in the stored lists order corresponding to the position of the identifier in the sequence order, and the processor is configured to use the identified sequence to send the corresponding further data or sequence identifier to the output for identification of a user.

According to a second aspect of the invention there is provided a method of matching biometrics using a computer system comprising, the steps of :storing a plurality of templates of items of biometric data, each template comprising a template identifier, storing a plurality of sequences, each sequence comprising data that corresponds to template identifiers in a stored sequence order, and comprising further data or a sequence identifier for relating to further data,

after a user has entered a series of items of biometric data into the input, matching each inputted item against templates in an template database by comparing each item with templates and by selecting a number of templates which satisfy predetermined matching criteria based on the inputted item, creating a list of selected templates for each inputted item,

storing the lists in a memory in a lists order corresponding to the input order of items in the series, identifying a sequence, in a sequence database, comprising data that corresponds to template identifiers in a stored sequence order, and comprising further data or a sequence identifier for relating to further data, in which each of the corresponding template identifiers in the sequence order relates to a selected template included in the list of selected templates which is in a position in the stored lists order corresponding to the position of the identifier in the sequence order, using the identified sequence to send corresponding data to an output for identification of a user.

With any aspect of the invention:

The identification of a sequence is preferably achieved by comparing templates corresponding to the template identifiers in the sequence database which are stored in a first position in sequence orders with the list of selected templates in the corresponding position, selecting those sequences where similarities of the compared templates in the first position satisfy predetermined requirements and storing the selected sequences as a set of remaining sequences, and identifying the sequence from only the set of remaining sequences. More preferably by comparing templates corresponding to the template identifiers in the set of remaining sequences which are stored in a second position in the sequence orders with the list of selected templates in the corresponding position, selecting those sequences where similarities of the compared templates in the second position satisfy predetermined requirements and storing the selected sequences as a set of still remaining sequences, and identifying the sequence from only the set of still remaining sequences. Preferably still by the matching mechanism by repeating the comparing of templates at multiple positions and preferably each position, or for as many positions as it takes for the still remaining sequences to reduce to zero, reducing the set of still remaining sequences used for identification to the selected sequences after each comparison. The predetermined requirements may be that the templates are identical.

Preferably how many items of biometric data are entered using the input is recorded. More preferably the sequence is identified from only the sequences in the sequence database which have the same number of template identifiers as the number of inputted items of biometric data recorded.

Preferably the template and sequence databases form part of a single database and/or the template identifier comprises a location within the database(s) such as being located in the same table as the corresponding sequence.

Preferably there are multiple servers in communication with each other, with the sequence and template databases being stored on separate servers and/or the memory being located on more than one server and/or the processor comprises multiple processors on the multiple servers.

Preferably the biometric item is an image of a fingerprint.

Preferably sequences in the sequence database comprise template identifiers corresponding to templates of prints of different fingers from the same individual.

Preferably the invention generates a verification similarity value for one or more, and preferably each, compared inputted item and template and stores it in a memory.

Preferably a choice is made from a plurality of sequences identified from the sequence database in which each of the corresponding template identifiers in the sequence order relates to a selected template included in the list of selected templates which is in a position in the stored lists order corresponding to the position of the identifier in the sequence order, by comparing the verification similarities corresponding to the compared templates corresponding to each identified sequence, and the chosen sequence is used to send the corresponding further data or sequence identifier to the output for identification of a user.

Preferably the verification similarities are normalised between a minimum and maximum value which are preferably 0 and 1 and/or the predetermined matching criteria comprise determining whether the verification similarities are greater or equal to a predetermined threshold value.

Preferably the template database comprises source data corresponding to templates, and preferably each template, which identifies the type of biometric such as fingerprint or retina scan and/or the type of reader used to measure the biometric. More preferably different threshold values are stored for different items for example being dependent on the position of the value in the series of inputted items and/or being dependent on the source data.

Preferably the templates conform to a subset of the BioAPI standard and/or the list of selected templates comprises a dynamic array and/or a vector.

Preferably the sequence data and/or list of selected templates comprises a dynamic array and/or a vector.

Preferably a user may add templates and/or sequences into the databases by inputting them through the input, preferably where a sequence to which templates are added automatically adjusts in length.

Embodiments will now be described, by way of example only, with reference to the accompanying figures in which:

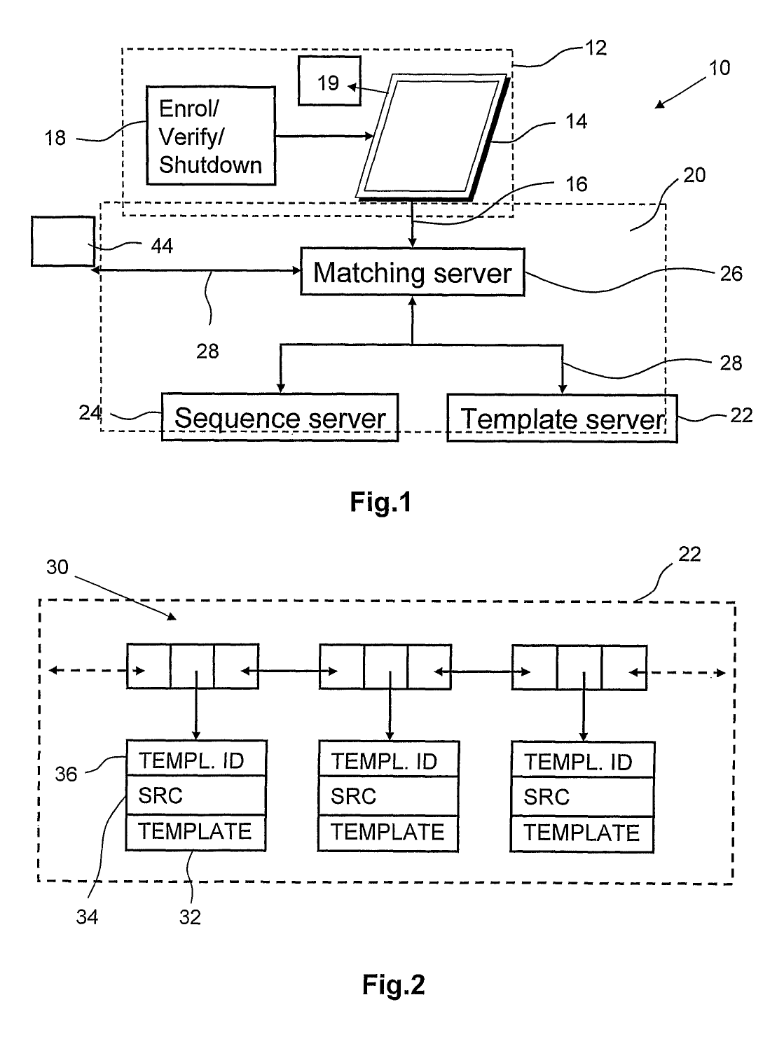

FIG. 1 is a schematic of a matching system in accordance with the invention;

FIG. 2 is a more detailed schematic of the template server;

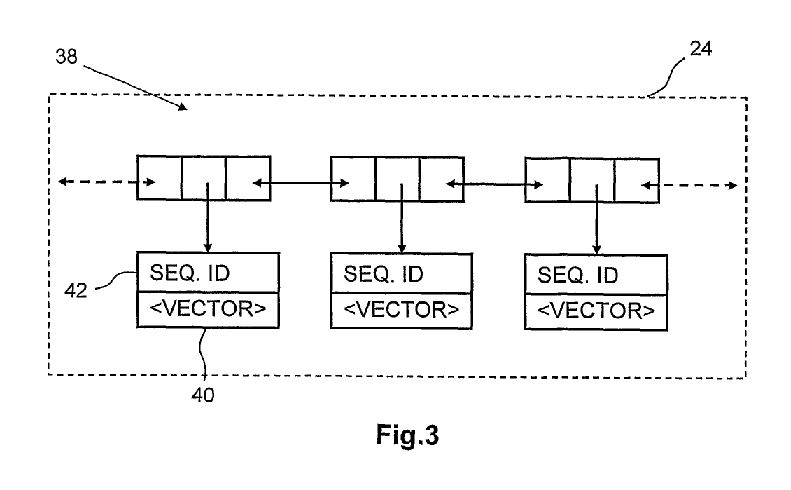

FIG. 3 is a more detailed schematic of the sequence server; and

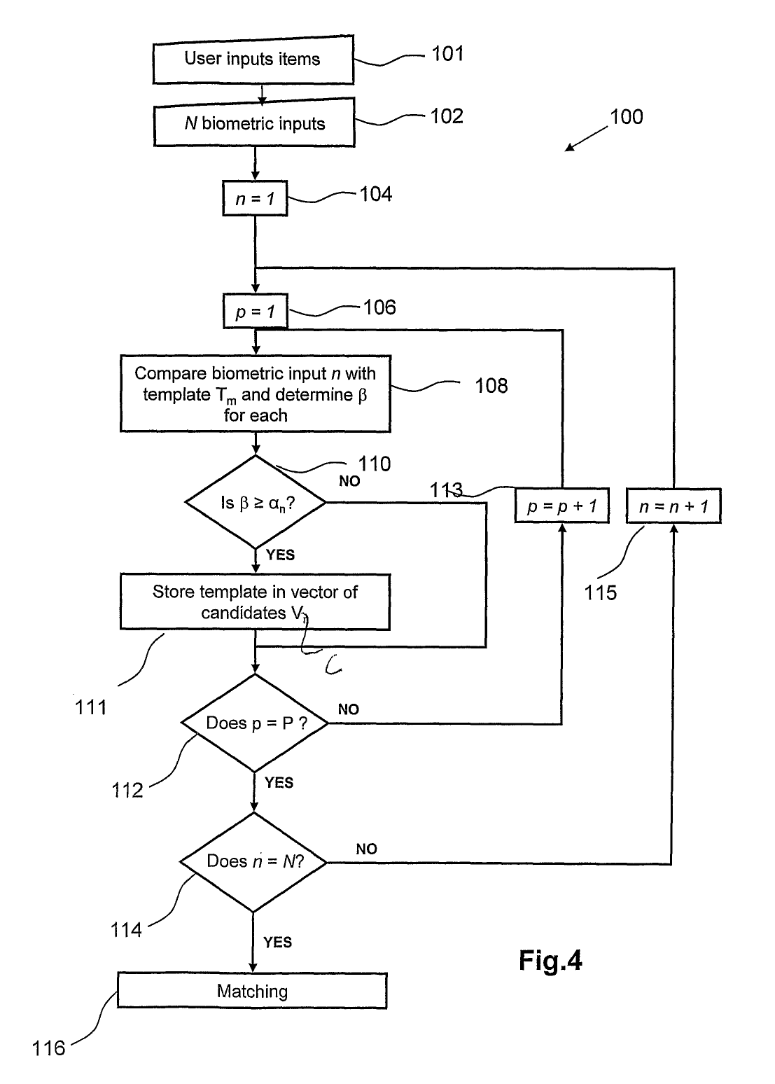

FIG. 4 is a flow chart of a matching process in accordance with the invention.

A matching system 10 is shown in FIG. 1. The matching system 10 comprises an interface 12, an engine 20, an output 19, and an external verification server 44.

The interface 12 is operable by a user, and comprises a biometric scanner 14, which in this embodiment is a finger print scanner but in alternative embodiments may comprise any biometric scanner or reader such as a retina scanner, a communication path 16 to the engine 20 and a function interface 18.

The biometric scanner 14 is capable of scanning a fingerprint (or alternatively retinas or other biometrics), and producing a biometric input signal which comprises input data, such as the location of certain features of a fingerprint, which can be used to identify a user as will be explained below. The biometric scanner 14 is capable of scanning a sequence of N biometric inputs, such as a set order of fingerprints of a user, and producing a sequence of N biometric input signals in that sequence.

The function interface 18 allows a user to input the desired operation of the matching system 10 by selecting, for example, whether to enrol a sequence of templates, verify a sequence of templates or shutdown the matching system 10.

The output 19 may take the form of a visual screen or another server which may for example allow or disallow access depending on the information sent from engine 20. Output 19 may be incorporated within the function interface 18.

The engine 20 is preferably a single application and comprises a template server 22, a sequence server 24 and a matching server 26. Each of the servers 22, 24, 26 are preferably standalone and communicate via communication paths 28, which operate using the TCP/IP protocol.

The software to run the engine in the manner described below could be written in pure Java.

A template database on the template server 22 is shown in detail in FIG. 2. In the template server is stored a total of P biometric templates 32, each of which relate to a single biometric input that, may have been entered into the server memory via path 16 from scanner 14. For example, any one of the biometric templates 32 may contain the location of certain features of a fingerprint that has been previously scanned by scanner 14. Each biometric template 32 has an associated source (SRC) identifier 34 and unique template ID 36.

The template server 22 comprises data in the form of a template linked list 30, which comprises references to each template in the form of their unique template ID 36.

The template server 22 can automatically add, remove and return biometric templates 32 as well as report how many biometric templates 32 it is storing (P), and also a list of unique template IDs 36.

The templates 32 may be stored as a customised (FP_xxxx) object with a “bean-like” (get/set) interface.

A sequence database on the sequence server 24 is shown in detail in FIG. 3. The sequence server 24 is analogous to the template server 22 in that it comprises a linked list in the form of a sequence linked list 38. The sequence server 24 stores sequence vectors 40, each with an associated unique integer identifier 42. Each sequence vector 40 comprises an ordered list of N integer objects which correspond to the unique template IDs 36 of the template server 22. The N integer objects are preferably stored as a vector though could be in an alternative form of dynamic array.

Preferably the nature of the sequence server 24 is such that it is not possible for two identical sequence vectors 40 or unique integer identifiers 42 to co-exist. Thus each sequence vector 40 and unique integer identifier 42 is truly unique.

The sequence server 24 allows for addition of a sequence vector 40 (with associated unique integer identifier 42), the return of sequence vectors 40 and unique integer identifiers 42 based on sequence length and the return of the number of sequence vectors 40 held (denoted hereinafter by M) and a list of unique integer identifiers 42.

Sequence vectors 40 preferably only comprise integer objects which correspond to existing unique template IDs 36. Therefore if a biometric template 32 is removed from the template server, any sequence vectors 40 referring to it are removed from the sequence server 24.

The matching server 26 is able to communicate with the template server 22 and the sequence server 24, as well as external verification server 44 via communication paths 28.

The external verification server 44 provides a platform independent “sockets level” interface to platform dependant Microsoft Windows DLLs and other third party biometric verification software which can compare the biometric input signal 16, with one of the biometric templates 32. Alternatively the verification sever is incorporated within the engine 20.

The external verification server 44 returns a fitness value β, representing the similarity of a biometric input signal received through path 16 and a biometric template 32. The matching server 26 is capable of comparing the fitness value β against a user defined fitness threshold αₙ, which may be unique for each biometric input signal received ranging from 1 to N. The threshold could vary according to the associated source (SRC) identifier 34, which itself may refer to the type of biometric (iris, fingerprint etc) that the template references and/or the type of scanner used to input the data and/or a non biometric source such as a BIOS ID, a network card MAC address or a GPS location.

The software for interfacing with the external verification server 44 may need to be written with that server in mind e.g. if platform specific access is required, Java Native Interface could be used or for example MS J# could be used as the implementation language.

An example of the matching server process 100 is shown in FIG. 4. At step S101 a user enters a series of fingerprints into the scanner 14. Biometric inputs are then constructed from the images of the finger print and sent via path 16 to engine 20.

Next the engine 20 determines the number of biometric input signals (N) at S102. At step S104 a system variable n (representing the current biometric input signal) is set at 1 (i.e. the first biometric input signal). A system variable p (representing the current biometric template 32) is set at 1 (i.e. the first biometric template 32 in the database of the template server 22), at step S106.

At step S108 the current biometric input signal is compared to the current biometric template 32 using the external verification server 44. This comparison produces a similarity value based on how similar the template 32 is to the input. Conventional matching mechanism can be used such as those that compare finger print features to generate a similarity value. The similarity value is then normalised into the float range so that it varies between 0 and 1 with 1 being a perfect match, and is stored as fitness value β.

At step S110, β is compared against the user defined fitness threshold αₙ by the matching server 26. If the fitness value β is less than the fitness threshold αₙ, then the biometric template 32 is ignored, and the process 100 skips to step S112. If it is equal or greater, then unique template ID 36 corresponding to the compared template 32 is added to a vector of candidates Cₙ, at step S111.

At step S112 it is determined if the value of the system variable p is equal to the number of templates P i.e. whether the entire list of templates 32 has been compared to the input signal. If it not equal the value of the system variable p is incremented at step S113 and the process returns to step S108.

Steps S108 to step S113 are repeated until the entire list of biometric templates (i.e. from 1 to P templates) has been compared to the biometric input signal 16. Once this the current biometric input signal 16 has been compared to the entire list of biometric templates 32, then it is determined whether the value of the system variable n is equal to N the total number of inputs determined at step S102. If not the system variable n is incremented at S115 and the process returns to step S108.

Steps S108 to step S115 are repeated until the entire list of N biometric input signals 16 has been processed.

Once n=N the sequence matching process then begins (as will be described below) at step S116.

The above process results in a vector of candidates Cₙ of variable length I for each biometric input signal 16 (where Iₙ is the length of the vector of candidates for biometric input n). Each vector of candidates Cₙ comprises a number of candidate unique template IDs 36. Each candidate unique template ID 36 can be represented by the notation c_{n,i}, where n is defined as the position of the biometric input signal in question within the inputted series, and i is the vector entry number. N.B i ∈ [1 . . . Iₙ]

Each vector of candidates therefore will consist of:

$$\begin{matrix}n = 1 & n = 2 & n = 3 & & n = N \\ {C}_{1} & {C}_{2} & {C}_{3} & & {C}_{N} \\ ↓ & ↓ & ↓ & & ↓ \\ {c}_{1 , 1} , & {c}_{2 , 1} , & {c}_{3 , 1} , & … & {c}_{N , 1} \\ {c}_{1 , 2} , & {c}_{2 , 2} , & {c}_{3 , 2} , & … & {c}_{N , 2} \\ {c}_{1 , 3} , & {c}_{2 , 3} , & {c}_{3 , 3} , & … & {c}_{N , 3} \\ & & & & \\ {c}_{1 , I 1} , & {c}_{2 , I 2} , & {c}_{3 , I 3} , & … & {c}_{N , IN}\end{matrix}$$

This is known as a “matching scenario”, and is the input to the sequence matching process 116 on FIG. 4.

The intention of the sequence matching process 116 is to identify one or more (although preferably one) sequence vectors 40 in the matching scenario, and to send the corresponding unique integer identifier 42 to output 19. This unique integer identifiers 42 identifies the user, and allows others to verify their identity or shut down the system for example.

A first embodiment of sequence matching process generates all possible sequences from the above matching scenario, starting with the sequence: [c_{1,1}, c_{2,1}, c_{3,1}, c_{4,1} . . . c_{N,1}] followed by: [c_{1,1}, c_{2,1}, c_{3,1}, c_{4,1} . . . c_{N,2}] and so on.

This generates I₁×I₂×I₃× . . . ×I_{N}

possible candidate sequences, all of which have to be checked against each of the M sequence vectors 40 held in the sequence server 24.

This results in:

$${S}_{1} = M {\prod }_{n = 1}^{N} {I}_{n} n ∈ [ 1 … N ]$$

searches.

An improved second embodiment only compares the biometric input signals with sequence vectors 40 of the same length, as the length of the inputted series (M_{N}=the number of sequences with length N).

This results in:

$${S}_{1} ( N ) = {M}_{N} {\prod }_{n = 1}^{N} {I}_{n} n ∈ [ 1 … N ]$$

searches.

In this case S₁(N)≦S₁.

Where the number of sequence vectors 40 held in the sequence server 24 of the appropriate length (M_{N}) is less than the number of possible candidate sequences generated from the matching scenario a third embodiment is beneficial.

$$i . e . {M}_{N} < {\prod }_{n = 1}^{N} {I}_{n} n ∈ [ 1 … N ]$$

Whether this is true is dependant on the population of the sequence server (i.e. how many sequence vectors 40 it stores), and also on the value of the user defined fitness threshold αₙ, which determines the length of each of the vectors of candidates Iₙ. In practice this is found to occur in most circumstances

The third embodiment of matching process according to the present invention is as follows:
1. A copy of all sequence vectors 40 of length matching the biometric input signal length (M_{N} sequence vectors 40) is made to matching server local memory,
2. Each entry (i.e. each unique template ID 36) of the first candidate vector C₁=[c_{1,1}, c_{1,2} . . . ] is checked against each of the first entries (integer objects) of each sequence vector 40 (N.B. integer objects correspond to unique template IDs 36). This involves I₁×M_{N} searches,
3. Sequence vectors 40 which do not result in a positive check are deleted leaving K₂ remaining potential sequence vectors 40, where K₂≦M_{N},
4. Each entry (i.e. each unique template ID 36) of the second candidate vector C₂=[c_{2,1}, c_{2,2} . . . ] is checked against each of the second entries (integer objects) of each sequence vector 40. This involves I₂×K₂ searches,
5. Sequence vectors 40 which do not result in a positive check are deleted leaving K₃ remaining potential sequence vectors 40, where K₃≦K₂,
6. This continues using candidate vector Cₙ against the nth entries (leaving Kₙ vectors) until either:
   a. there are no sequence vectors 40 left in memory (Kₙ=0), (for which see below), or
   b. n=N (i.e. all of the N candidate vectors have been searched).

The result may either be a single matching sequence vector 40, which is sent to the sequence server 24 for return of the unique integer identifier 42 and transmission to output 19 which may be used, for example, to identify the user, or more than one matching sequence vectors 40 (for which see below).

This results S₂(N) searches where S₂(N)≦S₁(N), dramatically speeding up the process by reducing the number of searches. It should also be noted that the slowest possible outcome is that S₂=S₁, although in reality very significant speed benefits should be seen.

There is a chance that the above method may return more than one matching sequence vector 40. The likelihood of this occurring is increased with larger values of M, and poorly set values of user defined fitness threshold αₙ, which determines the length of each of the vectors of candidates Iₙ.

In the event that the matching process returns more than one (or possibly zero) potential sequence vectors 40, it is desirable to examine the potential sequence vectors 40 to determine which one is the “best fit”. The present invention provides for this by using the following:

As discussed previously, when each biometric input signal 16 is compared to each biometric template 32 by the external verification server 44, a fitness value β is produced and compared to the user defined fitness threshold αₙ. The fitness value β represents the similarity of the biometric input signal and the biometric template 32. Each candidate sequence vector 40 can therefore be seen as having a corresponding vector of fitness values Bₘ=[β_{m,1}, β_{m,2}, β_{m,3} . . . β_{m,Im}] (where Iₘ is the length of the vector of fitness values).

Using a variation on the Euclidean distance measure, of which Pythagoras theorem is a simple case, a fitness value Fₘ for each sequence vector 40 can therefore be represented by:

$${F}_{m} = 1 - \frac{( {\sum }_{k = 1}^{{I}_{m}} \sqrt{{( 1 - {β}_{m , k} )}^{2}} )}{{I}_{m}}$$

Following this calculation, the candidate sequence vector 40 with the highest value of Fₘ is passed to the sequence server 24 which returns the unique integer identifier 42 as above. In the improbable event that two values of Fₘ are identical, the situation may be reported by the interface 18 or output 19.

1. A biometric matching apparatus comprising, an output, an input for acquiring items of biometric data, a memory and a processor, the memory comprises,
a template database in which is stored a plurality of templates of items of biometric data, each template comprising a template identifier,
and a sequence database in which is stored a plurality of sequences, each sequence comprising data that corresponds to template identifiers in a stored sequence order, and comprising further data or a sequence identifier for relating to further data,
wherein the apparatus comprises a matching mechanism which is configured to match, after a user has entered a series of items of biometric data into the input, each inputted item against templates in the template database by comparing each item with templates and by selecting a number of templates which satisfy predetermined matching criteria based on the inputted item, and creating a list of selected templates for each inputted item,
the matching mechanism is configured to store the lists in the memory in a lists order corresponding to the input order of items in the series, and is configured to identify a sequence from the sequence database in which each of the corresponding template identifiers in the sequence order relates to a selected template included in the list of selected templates which is in a position in the stored lists order corresponding to the position of the identifier in the sequence order,
and the processor is configured to use the identified sequence to send the corresponding further data or sequence identifier to the output for identification of a user.

2. Apparatus according to claim 1 wherein the identification of a sequence is achieved by the matching mechanism by comparing templates corresponding to the template identifiers in the sequence database which are stored in a first position in sequence orders with the list of selected templates in the corresponding position, the matching mechanism selecting those sequences where similarities of the compared templates in the first position satisfy predetermined requirements and storing the selected sequences as a set of remaining sequences, wherein the matching mechanism is configured to identify the sequence from only the set of remaining sequences.

3. Apparatus according to claim 2 wherein the identification of a sequence is achieved by the matching mechanism by comparing templates corresponding to the template identifiers in the set of remaining sequences which are stored in a second position in the sequence orders with the list of selected templates in the corresponding position, the matching mechanism selecting those sequences where similarities of the compared templates in the second position satisfy predetermined requirements and storing the selected sequences as a set of still remaining sequences, wherein the matching mechanism is configured to identify the sequence from only the set of still remaining sequences.

4. Apparatus according to claim 3 wherein identification of a sequence is achieved by the matching mechanism by repeating the comparing of templates at multiple positions and preferably each position, or for as many positions as it takes for the still remaining sequences to reduce to zero, reducing the set of still remaining sequences used for identification to the selected sequences after each comparison.

5. Apparatus according to claim 2, wherein the predetermined requirements are that the templates are (substantially) identical.

6. Apparatus according to claim 1 comprising an input measurement device which records how many items of biometric data are entered using the input.

7. Apparatus according to claim 6 wherein the matching mechanism is configured to identify the sequence from only the sequences in the sequence database which have the same number of template identifiers as the number of inputted items of biometric data detected by the input measurement device.

8. Apparatus according to claim 1 wherein the template and sequence databases form part of a single database

9. Apparatus according to claim 1 wherein the template identifier comprises a location within the database(s) such as being located in the same table as the corresponding sequence.

10. Apparatus according to claim 1 comprising multiple servers in communication with each other, with the sequence and template databases being stored on separate servers and/or the memory being located on more than one server and/or the processor comprises multiple processors on the multiple servers.

11. Apparatus according to claim 1 wherein the biometric item is an image of a fingerprint.

12. Apparatus according to claim 11 wherein sequences in the sequence database comprise template identifiers corresponding to templates of prints of different fingers from the same individual.

13. Apparatus according to claim 1 which generates a verification similarity value for one or more, and preferably each, compared inputted item and template and stores it in the memory.

14. Apparatus according to claim 13 wherein the matching mechanism is configured to choose from a plurality of sequences identified from the sequence database in which each of the corresponding template identifiers in the sequence order relates to a selected template included in the list of selected templates which is in a position in the stored lists order corresponding to the position of the identifier in the sequence order, by comparing the verification similarities corresponding to the compared templates corresponding to each
identified sequence, and wherein the processor is configured to use the chosen sequence to send the corresponding further data or sequence identifier to the output for identification of a user.

15. Apparatus according to claim 13 wherein the verification similarities are normalized between a minimum and maximum value which are preferably 0 and 1.

16. Apparatus according to claim 14 wherein the sequence is chosen from the verification similarities by using an equation substantially equivalent to
$$F = 1 - \frac{( {\sum }_{k = 1}^{I} \sqrt{{( X - β {,}_{k} )}^{2}} )}{I}$$
where X is a fixed number greater or equal to the maximum value of b, such as 1, k is the position in the sequence order and I corresponds to the number of verification similarities/templates, and wherein the identified sequence with the highest F value is chosen.

17. Apparatus according to claim 13 wherein the predetermined matching criteria comprise determining whether the verification similarities are greater or equal to a predetermined threshold value.

18. Apparatus according to claim 1 wherein the template database comprises source data corresponding to templates, and preferably each template, which identifies the type of biometric such as fingerprint or retina scan and/or the type of reader used to measure the biometric.

19. Apparatus according to claim 17 wherein different threshold values are stored for different items for example being dependent on the position of the value in the series of inputted items and/or being dependent on the source data.

20. Apparatus according to claim 1 wherein the templates conform to a subset of the BioAPI standard.

21. Apparatus according to to claim 1 wherein the list of selected templates comprises a dynamic array and/or a vector.

22. Apparatus according to to claim 1 wherein the sequence data and/or list of selected templates comprises a dynamic array and/or a vector.

23. Apparatus according to to claim 1 wherein a user may add templates and/or sequences into the databases by inputting them through the input, preferably where a sequence to which templates are added automatically adjusts in length.

24. A method of matching biometrics using a computer system comprising, the steps of:
storing a plurality of templates of items of biometric data, each template comprising a template identifier,
storing a plurality of sequences, each sequence comprising data that corresponds to template identifiers in a stored sequence order, and comprising further data or a sequence identifier for relating to further data,
after a user has entered a series of items of biometric data into the input, matching each inputted item against templates in an template database by comparing each item with templates and by selecting a number of templates which satisfy predetermined matching criteria based on the inputted item,
creating a list of selected templates for each inputted item,
storing the lists in a memory in a lists order corresponding to the input order of items in the series, identifying a sequence, in a sequence database, comprising data that corresponds to template identifiers in a stored sequence order, and comprising further data or a sequence identifier for relating to further data,
in which each of the corresponding template identifiers in the sequence order relates to a selected template included in the list of selected templates which is in a position in the stored lists order corresponding to the position of the identifier in the sequence order,
using the identified sequence to send corresponding data to an output for identification of a user.

25. (canceled)
